(19) United States
(12) Patent Application Publication
(10) Pub. No.: US 2026/0024287 A1
(43) Pub. Date: Jan. 22, 2026

(54) REAL NODES EXTENSION IN SCENE DESCRIPTION

(71) Applicant: InterDigital CE Patent Holdings, SAS, Paris (FR)

(72) Inventors: Loic Fontaine, noyal sur vilaine (FR); Pierrick Jouet, Rennes (FR); Patrice Hirtzlin, Betton (FR); Sylvain Lelievre, Montgermont (FR); Etienne Faivre d'Arcier, Saint Gonlay (FR); Serge Defrance, Rennes (FR)

(21) Appl. No.: 18/875,460

(22) PCT Filed: Jun. 12, 2023
(86) PCT No.: PCT/EP2023/065592

§ 371 Date: Dec. 16, 2024

(30) Foreign Application Priority Data
Jun. 17, 2022 (EP) 22305885.0

(51) Int. Cl. G06T 19/00; G06T 9/00; G06T 17/00

(52) U.S. Cl. CPC G06T 19/006; G06T 9/001; G06T 17/00; G06T 2210/32; G06T 2210/61

(57) ABSTRACT

Methods, device and data stream are provided to generate, transmit and decode scene descriptions of extended reality scenes. According to the present principles, the scene graph links nodes and comprises an information indicating which nodes correspond to objects of a first list of 3D models corresponding to objects of the real environment of the scene and/or which nodes correspond to objects of a second list of 3D models corresponding to virtual objects of the scene.

### 1. TECHNICAL FIELD

The present principles generally relate to the domain of extended reality scene description and extended reality scene rendering. In particular, the present principles relate to the description of the management of objects of the real environment in the description of a 3D scene. The present document is also understood in the context of the formatting and the playing of extended reality applications when rendered on end-user devices such as mobile devices or Head-Mounted Displays (HMD) like see-through glasses.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way that is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Binary representation of real objects may also be comprised in nodes of the scene description. Such representations of real object may have been obtained, for example by scanning the real environment. Scene description frameworks ensure that the timed media and the corresponding relevant virtual content are available at any time during the rendering of the application. Scene descriptions can also carry data at scene level describing of how the scene objects behave and interact at runtime for immersive XR experiences. The management of the representations of real objects (real and/or virtual, a user being a real object) is a technical challenge as they may be used for different processing at the rendering. There is a lack of a solution of scene description that indicates which objects of the scene comprise a representation of a virtual object and which objects comprise a representation of an object of the real environment.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for generating an extended reality scene description. The method comprises obtaining a first list of 3D models corresponding to objects of a real environment of the scene and a second list of 3D models corresponding to virtual objects of the scene. Then, a scene graph is generated, the scene graph links nodes and comprises an information indicating which nodes correspond to objects of the first list and which nodes correspond to objects of the second list. The extended reality scene description is encoded in a data stream, with information at a node level and information at a scene level.

In an embodiment, the information is an array of indices of the nodes corresponding to objects of the first list stored at the scene level. In another embodiment, the information is an array of indices of the nodes corresponding to objects of the second list stored at the scene level. In another embodiment, the nodes of the scene graph comprise an information indicating whether the node corresponds to an object of the first list or to an object of the second list. All these embodiments maybe combined to duplicate or certify the information.

The present principles also relate to a device implementing the method above. The present principles also relate to a method and a device for decoding and processing a scene description generated according to the method above. The present principles also relate to a data stream carrying data representative of a scene description generated according to the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 shows an example graph of an extended reality scene description according to the present principles;

FIG. 2 shows an example architecture of an XR processing engine which may be configured to implement a method described in relation with the present principles;

FIG. 3 shows an example of an embodiment of the syntax of a data stream encoding an extended reality scene description according to the present principles;

FIG. 4 shows an example of a rendering of an extended reality scene.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

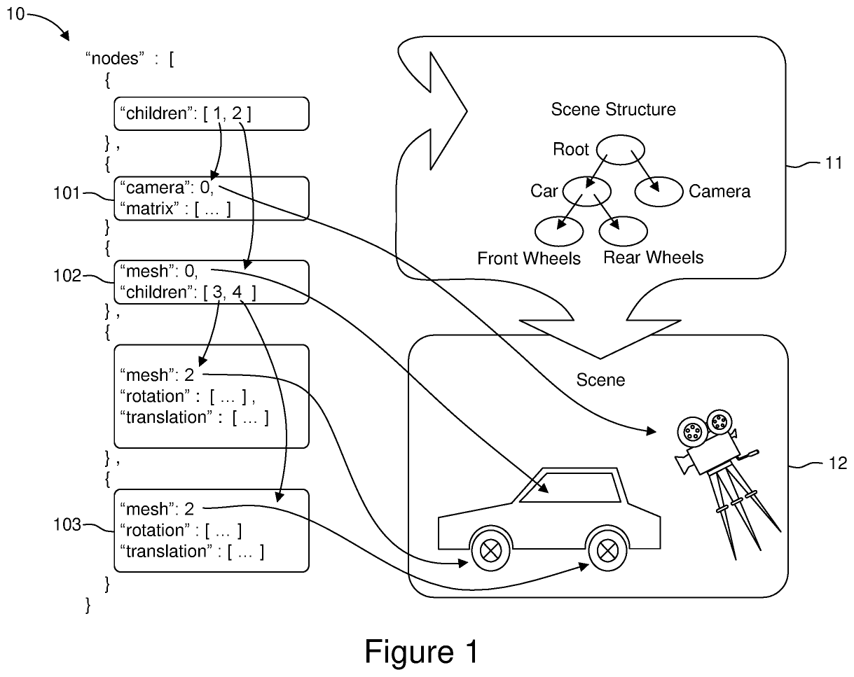

FIG. 1 shows an example graph 10 of an extended reality scene description. In this example, the scene graph may comprise descriptions of real objects, for example ‘plane horizontal surface’ (that can be a table or a road) and descriptions of virtual objects 12, for example an animation of a car. Scene description is organized as an array 10 of nodes. A node can be linked to child nodes to form a scene structure 11. A node can carry a description of a real object (e.g. a semantic description) or a description of a virtual object. In the example of FIG. 1, node 101 describes a virtual camera located in the 3D volume of the XR application. Node 102 describes a virtual car and comprises an index of a representation of the car, for example an index in an array of 3D meshes. According to the present principles, a node may also comprise an index of a representation of this real object. This representation may have been obtained, for example, by a scanning of the real environment or, for example, may be a model generated by a content creator. This representation must correspond to the real object described in this node, and, so, is localized in the 3D scene. In such a scene description, there is no longer means to distinguish between real nodes and virtual nodes as both comprise a 3D representation. According to the present principles, information about the nature of a node in the scene description is provided to the renderer.

The scene description may comprise numerous arrays comprising descriptions of various aspect of the scene, for example an array containing instructions for several animations, an array containing meshes of several virtual or real objects or an array comprising material descriptions. Node 103 is a child of node 102 and comprises a description of one wheel of the car. The same way, it comprises an index to the 3D mesh of the wheel. The same 3D mesh may be used for several objects in the 3D scene as the scale, location and orientation of objects are described in the scene nodes. Scene graph 10 also comprises nodes that are a description of the spatial relation between the real objects and the virtual objects.

XR applications are various and may apply to different contexts and real or virtual environments. For example, in an industrial XR application, a virtual 3D content item (e.g. a piece A of an engine) is displayed when a reference object (piece B of an engine) is detected in the real environment by a camera rigged on a head mounted display device. The 3D content item is positioned in the real-world with a position and a scale defined relative to the detected reference object. In the same way, actions on virtual objects may be performed when a collision between real or virtual objects is detected, that is a collision between two real objects, two virtual objects or a real object and a virtual object.

For example, in an XR application for interior design, the color of a displayed virtual piece of furniture is changed when the user touches a virtual control object or when the user touches a real table. In another application, an audio file might start playing when two moving displayed virtual objects collide. In another example, an ad jingle file may be played when the user grabs a can of a given soda in the real environment. However, detecting collision (or contacts) between real or virtual objects and rendering realistic reactions of virtual objects requires the use of a physics engine that is expansive in terms of memory and processing resources. So, it is important to have a scene description that accurately describes the different kinds of behaviors linked to collisions in order to optimize the use of the physics engine. Such an XR scene description format is provided herein according to the present principles.

An XR application may also augment a video content rather than a real environment. The video is displayed on a rendering device and virtual objects described in the node tree are overlaid when timed events are detected in the video. In such a context, the node tree comprises only virtual objects descriptions.

Real assets, that are representations of real objects, are very useful to increase XR experience. For example, the scan of the room allows the management of collisions between virtual objects and real objects. This can also be used for rendering purpose, for instance, not to render real objects in the case of a see-through XR device or, for example to ensure coherent lighting between real and virtual objects including shadow management. The present principles provide a solution to indicate the nature of any node of a scene description.

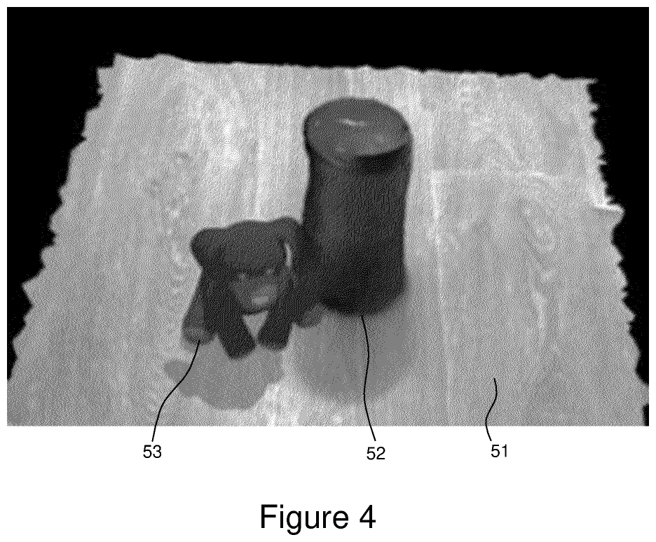

FIG. 4 shows an example of a rendering of an extended reality scene. In the example of FIG. 5, object 51 is a real table, object 52 is a real speaker and object 53 is a virtual teddy bear. A scene description generated according to the present principles allows the rendering system to estimate the shadows on real objects in order to generate a consistent shadow for the teddy bear. In such an example, it is key for the rendering system to distinguish between real and virtual objects of the extended reality scene.

According to the present principles, a scene description comprises information about nodes comprising a representation of real objects in the scene to obtain a rendering close to reality. In a first embodiment, the scene description comprises an array of real nodes at the scene level. For example, in the scope of the MPEG-I Scene Description framework using the Khronos glTF extension mechanism to support additional scene description features, a “MPEG_real_nodes” extension is defined at scene level. The semantics of the MPEG_real_nodes at scene level is defined by the following table:

| Name | Type | Description |
|---|---|---|
| realNodes | Array | Indices of the nodes in the nodes array |
| | | that correspond to real objects. |

An AR scene with a real scan of the environment allows the management of collision between real and virtual world. In AR experience, the mesh and the texture of the real objects are not visible (the real world is already visible through the AR device), only mesh collider is used. In other kind of applications, for example a distant XR experience, the representation of real objects (a scanned point of clouds or a 3D model) may be rendered and displayed jointly with the virtual objects.

According to the present principles, the “Real Node” attribute provides information to the renderer to manage the visibility of real objects. In an AR scene, the lighting can be very important. It allows to have a consistent management of shadows for virtual objects. Different cases have to be taken into account to compute the output of an illumination shader. Output of the illumination shader provides the color of the pixels of the final composed image and its computation differs depending on whether the pixel belongs to an un-shadowed real object, a real object in the shadow cast by a real surface, a real object in the shadow cast by a virtual surface, an un-shadowed virtual object, or a shadowed virtual object.

To distinguish between cases, a binary flag is supplied to the shader, set to 0 for vertices corresponding to the 3D model of real objects and set to 1 for vertices corresponding to the additional virtual objects. Two depth maps are also generated from each light estimated position: one for the real object (i.e., the textured mesh) and another for the virtual objects. The “Real Node” attribute provides the necessary information to the renderer, so shadows are not generated for real objects because they already exist.

As the notion of “real node” relates to nodes in the scene graph, this notion also relates to light sources. In AR framework, real lights are materialized through virtual lights to illuminate virtual objects for consistent light rendering. Each light is associated with at least one node. The light inherits the “real node” attribute from the node. This “real node” attribute may be used regarding the possible control of the lights.

At the rendering side, during runtime, the application iterates, at scene level, on each defined node. The information contained in the scene description (collision, virtual lights) and the information obtained from the application is used differently by the renderer. For the sake of the description, the invention is detailed in the scope of the MPEG-I Scene Description framework using the Khronos glTF extension mechanism to support additional scene description features. However, the present principles may fit to other existing or upcoming descriptions of XR scene. As illustrated in FIG. 1, each glTF node can comprise an array called children that comprises the indices of its child nodes. So, each node is one element of a hierarchy of nodes, and together they define the structure of the scene as a scene graph. A possible syntax example of such real node description in the MPEG-I Scene Description is provided below:

```
{
  “extensionsUsed”: [
    “MPEG_scene_interactivity”,
    “MPEG_real_nodes”
  ],
  “scene”: 0,
  “scenes”: [
    {
      “name”: “Scene”,
      “nodes”: [
        0,
        1,
        2,
        3,
        4
      ]
    }
  ],
  “extensions”: {
    “MPEG_real_nodes”: {
      “realNodes”: [ 0 ]
    },
    ...
  },
  “nodes”: [
    {
      “name”: “Node0”,
      “mesh”: 0,
      “matrix”: [ 1, 0, 0, 0,
            0, 0, −1, 0,
            0, 1, 0, 0,
            −16.2, −5.5, 44.8, 1
          ]
    },
    {
      “name”: “Node1”,
      “mesh”: 1,
      “matrix”: [ 1, 0, 0, 0,
            0, 0, −1, 0,
            0, 1, 0, 0,
            15, 5, −18, 1
          ]
    },
    {
      “name”: “Node2”,
      “mesh”: 2,
      “matrix”: [ 1, 0, 0, 0,
            0, 0, −1, 0,
            0, 1, 0, 0,
            −5, 7, −1, 1
          ]
    },
    ...
  ]
  ...
}
```

In a second embodiment, the scene description comprises, at the scene level a list of virtual objects. Thus, by parsing this list, the renderer is informed that nodes having a pointer to a 3D model that are listed are virtual objects and the nodes having a pointer to a 3D model not listed are real objects. In this second embodiment, the array attribute is called “VirtualNodes”. The second embodiment may be combined with the first embodiment. Indeed, as the scene graph may comprise nodes that are not directly related to objects with a 3D model, it may be valuable for the renderer to have, at the same time, a list of the real objects and a list of virtual objects, allowing the renderer to distinguish object nodes from other types of nodes.

In a third embodiment, the information about the nature of the node is indicated in an attribute at the node level. For example, an attribute “isRealObject” at the node level may be set to 1 when the associated 3D model corresponds to an object of the real environment of the application and to 0 when it corresponds to a virtual object. In a variant, a “isVirtual” attribute at the node level is set to 1 when the object is virtual and to 0 when the object is real.

The third embodiment may be combined with the first or second embodiment. Indeed, the information about the real or virtual nature of nodes may be indicated at the scene level and at the node level. The renderer may use this duplicated information for post-processing operation.

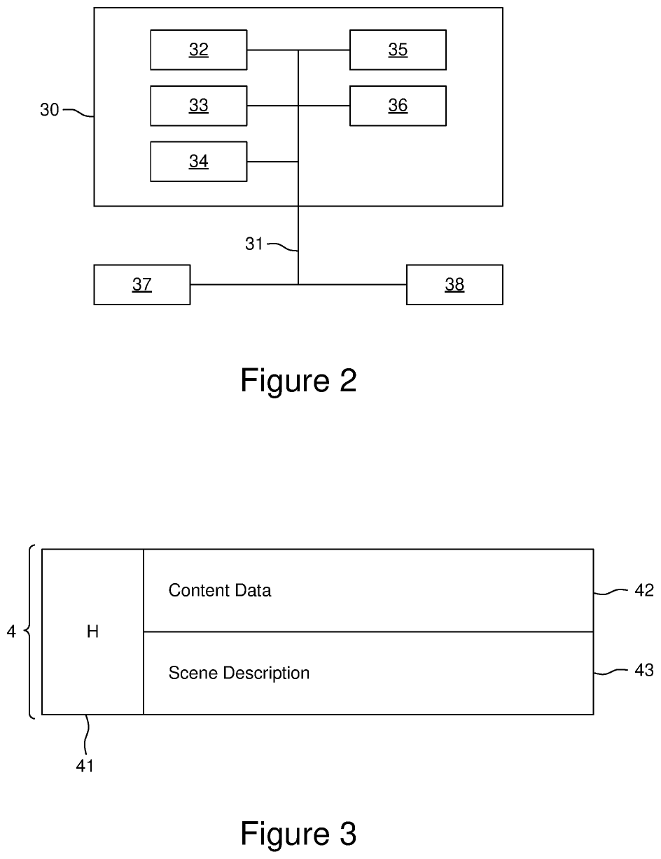

FIG. 2 shows an example architecture of an XR processing engine 30 which may be configured to implement the present principles. A device according to the architecture of FIG. 2 is linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 2), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles, and belongs to a set comprising:
a mobile device;
a communication device;
a game device;
a tablet (or tablet computer);
a laptop;
a still picture camera;
a video camera.

FIG. 3 shows an example of an embodiment of the syntax of a data stream encoding an extended reality scene description according to the present principles. FIG. 3 shows an example structure 4 of an XR scene description. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure also comprises a payload comprising an element of syntax 42 and an element of syntax 43. Syntax element 42 comprises data representative of the media content items describes in the nodes of the scene graph related to virtual elements. Images, meshes and other raw data may have been compressed according to a compression method. Element of syntax 43 is a part of the payload of the data stream and comprises data encoding the scene description as described according to the present principles.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for generating a scene description of an extended reality scene, the method comprising:
obtaining a first list of three-dimensional (3D) models corresponding to objects of a real environment of the extended reality scene and a second list of 3D models corresponding to virtual objects of the extended reality scene;
generating the scene description including a scene graph linking nodes and comprising information indicating which nodes correspond to objects of the first list and which nodes correspond to objects of the second list; and
encoding the scene description in a data stream.

2. The method of claim 1, wherein the information is an array of indices of the nodes corresponding to objects of the first list stored at a scene level.

3. The method of claim 1, wherein the information is an array of indices of the nodes corresponding to objects of the second list stored at a scene level.

4. The method of claim 1, wherein each node of the scene graph comprises information indicating whether the node corresponds to an object of the first list or to an object of the second list.

5. A device comprising a memory associated with a processor configured for:
obtaining a first list of three-dimensional (3D) models corresponding to objects of a real environment of an extended reality scene and a second list of 3D models corresponding to virtual objects of the extended reality scene;
generating a scene description including a scene graph linking nodes and comprising information indicating which nodes correspond to objects of the first list and which nodes correspond to objects of the second list; and
encoding the scene description in a data stream.

6. The device of claim 5, wherein the information is an array of indices of the nodes corresponding to objects of the first list stored at a scene level.

7. The device of claim 5, wherein the information is an array of indices of the nodes corresponding to objects of the second list stored at a scene level.

8. The device of claim 5, wherein each node of the scene graph comprises information indicating whether the node corresponds to an object of the first list or to an object of the second list.

9. A method for rendering an extended reality scene, the method comprising:
obtaining, from a data stream, a scene description of the extended reality scene from a data stream;
decoding, from the scene description, a scene graph linking nodes and comprising information indicating which nodes correspond to objects of a real environment of the extended reality scene and which nodes correspond to virtual objects of the extended reality scene; and
processing the nodes of the scene graph according to the information.

10. The method of claim 9, wherein the information is an array of indices of the nodes corresponding to objects of the real environment stored at a scene level.

11. The method of claim 9, wherein the information is an array of indices of the nodes corresponding to virtual objects stored at a scene level.

12. The method of claim 9, wherein each node of the scene graph comprises information indicating whether the node corresponds to an object of the real environment or to a virtual object.

13. A device comprising a memory associated with a processor configured for:
obtaining, from a data stream, a scene description of an extended reality scene;
decoding, from the scene description, a scene graph linking nodes and comprising information indicating which nodes correspond to objects of a real environment of the extended reality scene and which nodes correspond to virtual objects of the extended reality scene; and
processing the nodes of the scene graph according to the information.

14. The device of claim 13, wherein the information is an array of indices of the nodes corresponding to objects of the real environment stored at a scene level.

15. The device of claim 13, wherein the information is an array of indices of the nodes corresponding to virtual objects stored at a scene level.

16. The device of claim 13, wherein each node of the scene graph comprises information indicating whether the node corresponds to an object of the real environment or to a virtual object.

17-20. (canceled)
